(19) United States
(12) Patent Application Publication
(10) Pub. No.: US 2009/0164043 A1
(43) Pub. Date: Jun. 25, 2009

(54) Platform to Perform Remote Commercial Transactions by Means of Vending Machines

(75) Inventors: Alvaro Alejandro Cardozo Martinez, Montevideo (UY); Gustavo Daniel Rodriguez Botana, Montivideo (UY); Martin Katzenstein Garibaldi, Montevideo (UY); Julian Oreggioni Gamou, Montevideo (UY)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Pranasys Sociedad Anonima, Montevideo (UY)

(21) Appl. No.: 12/341,724

(22) Filed: Dec. 22, 2008

(30) Foreign Application Priority Data
Dec. 21, 2007 (UY) 30.836

(51) Int. Cl. G06F 17/00; G06Q 40/00

(52) U.S. Cl. 700/231; 705/35

(57) ABSTRACT

A new system for the sale of intangible products through vending machines, featuring a controlling device placed within a vending machine, an application for the member of the staff of the vending machine (VM) operator working in the field (which runs on his/her cell phone), one or more applications for the members of the staff of the VM operator working within the facilities of the VM operator (running on personal computers), and a computer system which manages all of the above-mentioned components.

### BACKGROUND OF THE INVENTION

There are two widespread protocols of use concerning the operation of vending machines: the MDB protocol, issued by the NAMA (See MDB Protocol. Multi-Drop Bus/Internal Communication Protocol. MDB/ICP. NAMA (National Automatic Merchandising Association). Version 3.0, 26 Mar. 2003), which consists of a voluntary standard with a high acceptance level, which regulates the communication between the machine controller and the different peripherals coexisting with it, such as coin mechanisms, bill validators, and peripherals which do not use cash, such as credit card readers (“cashless device”), etc. The other one is the DEX protocol, issued by EVA (See EVA-DTS Protocol. Data Transfer Standard. EVA (European Vending Association). Version 6.0, May 2004). It also consists of a voluntary, comprehensive standard, widely used by vending machines. It defines how the communication should be established between the controller of one of the machines and another device, so that the first one conveys to the second data referred to sales, alarms and diverse types of events.

The prior art shows numerous antecedent cases referred to the sales of products through vending machines, which use alternative payment methods (e.g. “Vending machine purchase via cellular telephone”, U.S. Pat. No. 6,584,309; “A system to make transactions through vending machines from mobile phone terminals” Pat. ES 2,190,878; “Text message payment”, Pat. US 20070203836, et al).

It is also possible to find diverse systems which, through the DEX protocol, obtain the data provided by vending machines. However, the sale of intangible products through vending machines has no antecedents. On top of this, no other device has ever before included all the functions performed by the device herein described.

### BRIEF DESCRIPTION OF THE DRAWINGS

FIG. 1 is a photograph of a controlling device placed within a vending machine, in accordance with one embodiment of the invention.

FIG. 2 illustrates an exploded view of a container for a controlling device, in accordance with one embodiment of the invention.

FIG. 3 illustrates an application running on a cellular telephone of an employee working in the field, in accordance with one embodiment of the invention.

FIG. 4 illustrates a block diagram of a computer system, in accordance with one embodiment of the invention.

FIG. 5 illustrates a replenishment query screen, in accordance with one embodiment of the invention.

FIG. 6 is a photograph of a seller/replenisher replenishing a vending machine.

FIG. 7 illustrates a replenishment query screens in accordance with one embodiment of the invention.

FIG. 8 illustrates a settlement screen in accordance with one embodiment of the invention.

### DESCRIPTION OF THE INVENTION

The innovation whose authorship and patentability are hereby claimed is the result of the action of a specific combination of hardware and software, aimed at the operative convergence of vending machines (hereinafter “VM”) and cellular communication systems.

Composed of a single technological platform, it conciliates different business sources for vending machine operators—thus enlarging their product offer—while reducing their service and maintenance costs through the action of a vending machine inner device, with an innovative design, which is one of the original features of the invention. This allows for online communication with every machine by means of cellular technology.

In this way it makes it possible, for instance, to purchase traditional products by using the user's cell phone as a payment method. As a matter of fact, once a VM is connected to a cellular operator the platform allows users to shop and pay later, along with their telephone bill, or to debit the shopping amount from a pre-paid cell account.

Likewise, it makes it possible to get through VMs a new kind of products, of an intangible nature, such as prepaid cell phone top-ups, show tickets, public transport tickets, product coupons, frequent buyer bonuses, etc. Thus, the VM operator's traditional offer is increased by a new product, which does not require any additional Spiral or stock, while offering new cost-efficient services.

Lastly, the platform designed enables VM remote management, thus giving access to significant, real-time telemetry data, for maintenance and routine operations, namely: product and money stock data in each machine, detection of miscellaneous technical failures (cold chain monitoring, jammed products, jammed coin mechanisms, etc.).

All the operations are recorded at the same time as they are performed and can be monitored. The VM operator can view the whole operation in real time and settle—also in real time—any problems faced by the consumer or its own staff.

To sum up: the system increases the profitability for the VM operator by lowering its management costs, by increasing sales through the availability of a new payment method, and by adding to the available infrastructure a new product which, due to its very nature, does not entail restocking costs.

The system is composed of three main elements: A controlling device placed within a vending machine (hereinafter “UDANA”); an application for the member of the staff of the VM operator working in the field (which runs on his/her cellular phone) for machine maintenance and stock replenishment (hereinafter “TELCOMOBILE”); one or several applications for the members of the staff of the VM operator working in its facilities (which runs on personal computers), and lastly the managing computer system, consisting of computer hardware and software (hereinafter “TELCOVENDING”).

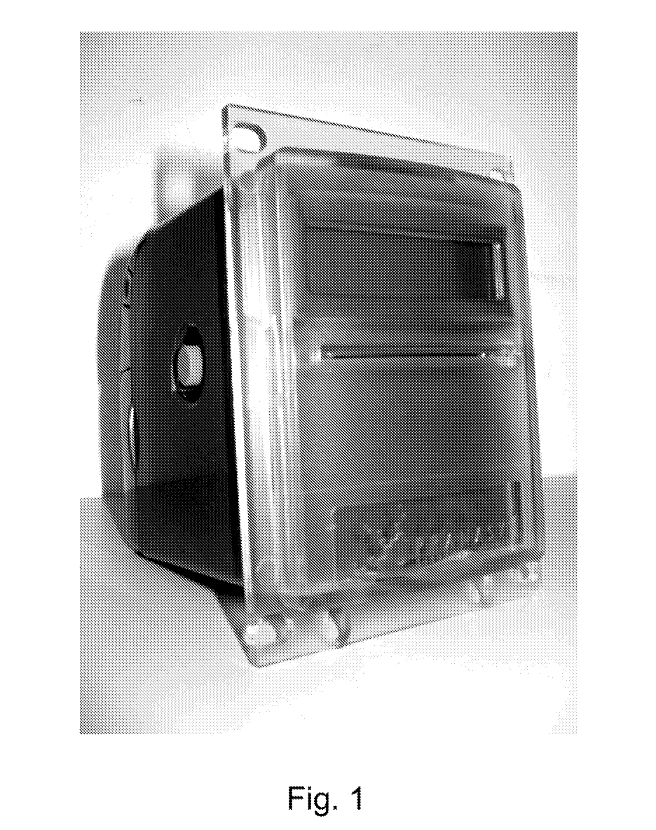

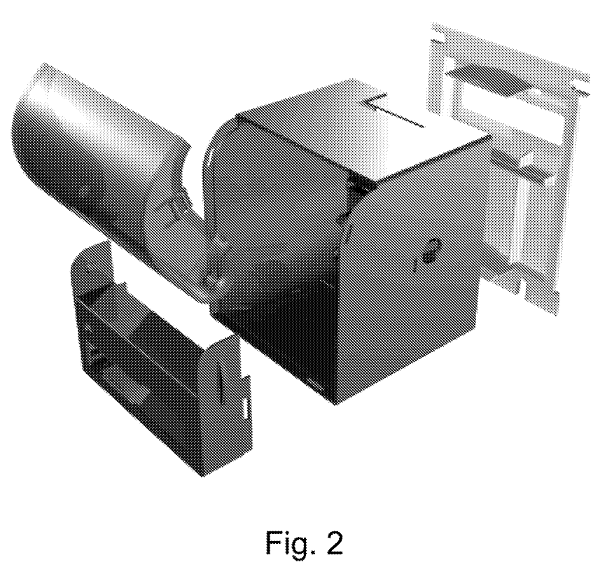

The UDANA device (see FIGS. 1 and 2) which acts within the vending machine is basically the “heart” of the system. Its unique design features have made it worth of a separate Invention Patent claim (See Pending patent number UY/30685, “New electronic device for the sale of intangible products through vending machines”.); it consists of a container with circuits and interfaces. It includes a cellular data MODEM, which uses the GPRS protocol.

Once installed in the vending machine, the UDANA device—along with its firmware and the above-mentioned data transmission line—is connected to the internal processor of the VM through a special cable. This connection can be made through the standard protocols MDB and DEX (among others).

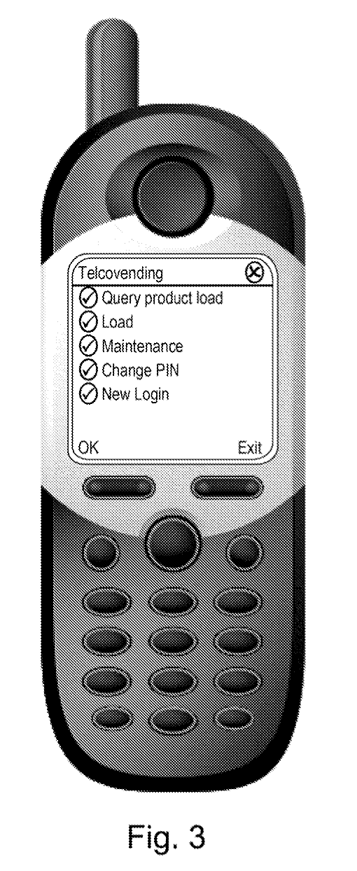

TELCOMOBILE (see FIG. 3) is the application which runs on a cellular phone and acts as an interface between TELCOVENDING and the members of the staff of the VM operator working in the field. Through TELCOMOBILE an employee can, for instance, check the products that need replenishment in a machine, needless of being in front of it. Likewise, the employee informs TELCOVENDING about the activity he/she performed in the machine (e.g. quantity of products replenished, beginning of a maintenance task, etc.).

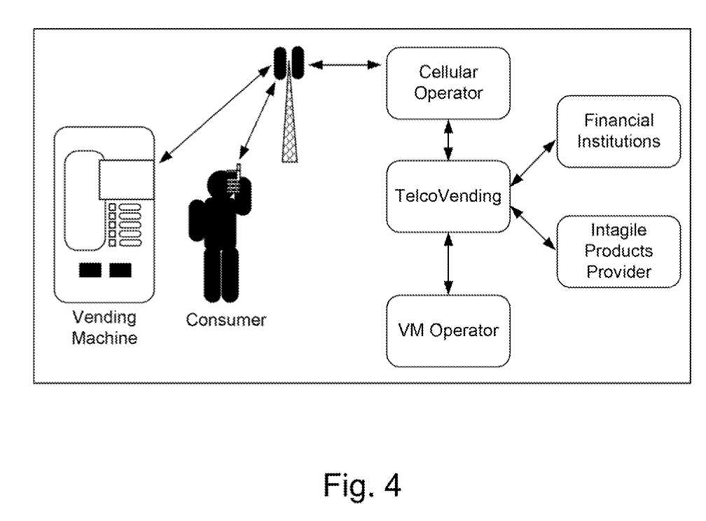

TELCOVENDING (see FIG. 4) is a computer system, composed of procedures, hardware equipment (servers, communication equipment, etc.) and software components (services, web services, management services, databases, etc.) able to intercommunicate cellular operators platforms (top-up, SMS, USSD, etc.), financial institutions (banks, credit card issuers, collection networks, transactional switches, etc.), other diverse institutions (e.g., specific systems of VM operators, specific systems of providers of intangible products, etc.) and hardware components for specific or general purposes (e.g. ATMs or the UDANA device itself). The communication can be established by means of standard protocols (e.g. ISO 8583) or proprietary protocols.

For VM remote management, TELCOVENDING integrates two different data sources. On the one side, data provided by the UDANA device, which informs about the activity regarding the VM operation, and on the other side data provided by TELCOMOBILE about the activity of the employee. By using the TELCOVENDING software components, the VM operator have access to the data in an integrated way, namely: inventory of each product, contents of the money bag (honorgard), status of the functional indicators of the machine (refrigerating temperature, etc), anomalous operation conditions (such as power cutoffs, missing products, error status of coin mechanism), as well as other conditions which prevent the machine from continuing selling on a regular basis.

### Operation

Both the purchase of intangible products and the purchase of traditional products are transactions initiated by the consumer. The latter establishes communication with TELCOVENDING and expresses his intention to make a transaction in the vending machine where the device is installed. The communication between the user and TELCOVENDING can be made directly, e.g. through an SMS, or through the UDANA device by using a keyboard, a wireless connection (e.g. bluetooth or NFC) or any other user interface with similar features.

Self-sticking labels are placed on the front of the VM, with clear instructions about the steps to be followed.

The purchase of intangible products through a vending machine is made in the following way (see FIG. 4):

1) The consumer stands in front of the machine and communicates with TELCOVENDING, through any of the cell phone communication modes, namely: IVR, SMS, Mobile Internet, USSD, etc. and expresses his/her intention to purchase an intangible product, e.g. cell phone top-up.

2) Next, TELCOVENDING takes control of the VM by means of the UDANA device, so as to meet the consumer's request. Then the consumer inserts coins or bank notes as if he were to purchase a traditional product, and follows the instructions given by the UDANA device.

3) TELCOVENDING establishes communication with the corresponding system (e.g. cell phone operator top-up platform) in order to perform the transaction requested (e.g. cell phone top-up).

4) Depending on the type of operation, the consumer receives a confirmation about the result of the transaction through a printed ticket, or a message on the UDANA display or even on his/her cell phone itself.

The purchase of tangible products through a vending machine is made in the following way (see FIG. 4):

1) The consumer stands in front of the machine and establishes communication with TELCOVENDING, through any of the cell phone communication modes: IVR, SMS, Mobile Internet, USSD, etc. and expresses his/her intention to purchase a product.

2) Next, TELCOVENDING takes control of the VM by means of the UDANA device, so as to fulfill the consumer's request.

3) Instead of paying by inserting coins or bank notes in the VM, the consumer pays by means of his/her cell phone account (similar to a subtraction of minutes in a prepaid cell phone account), or by means of a credit or debit card associated to the cell phone number, or through other similar payment methods (e.g. lunch tickets or corporate benefit systems associated to TELCOVENDING).

4) Depending on the type of transaction, the consumer receives a confirmation about the result of the transaction through a printed ticket, a message on the UDANA display or even on his/her cell phone.

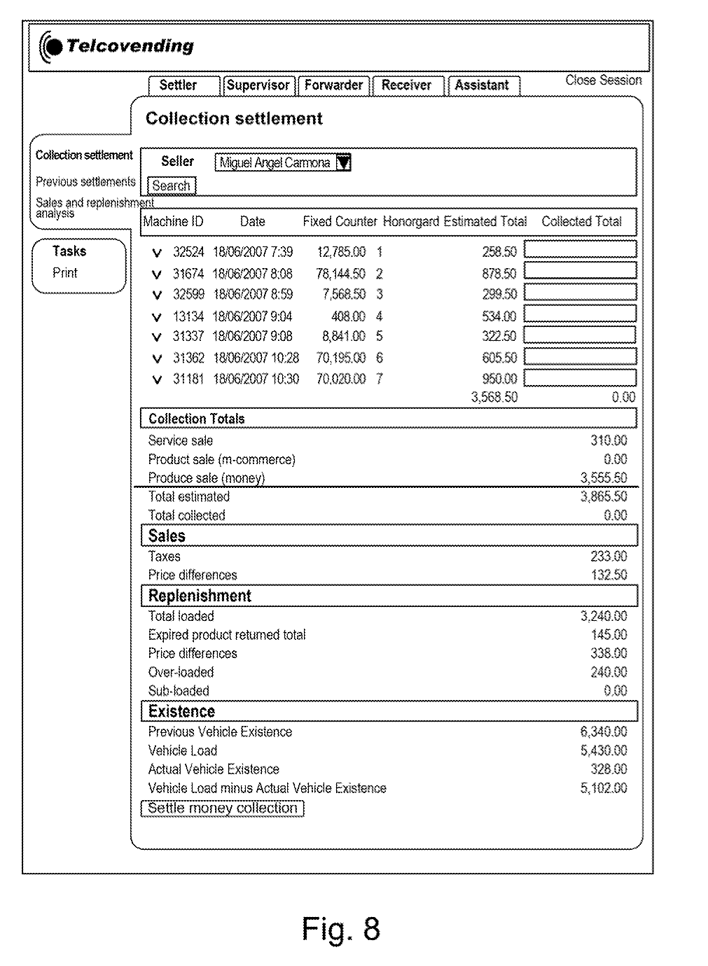

The use of the system for the VMs management requires, in addition to the incorporation of the above-mentioned hardware components, one or more applications (e.g. web applications, as shown by FIG. 8) in the Distribution Center for the different employees of the VM operator (Forwarder, Receiver, etc.) and of a series of processes involving the integrated stages of the solution. Next the main features of the above-mentioned processes are described in broad lines:

1) Vehicle Loading:
The system establishes which products must be loaded into the vehicle, based on which machines are to be visited on a daily basis.
The system calculates the quantities of each product to be loaded, based on the sales made by the machine since the last visit, and taking into account other significant variables (e.g. current stock of products in the vehicle, quantity of products not replenished during the last visit, etc.).
The Forwarder obtains from the system the products and quantities to be loaded into the vehicle.
The Forwarder indicates in the system the quantity actually loaded, as per availability in the Distribution Center.

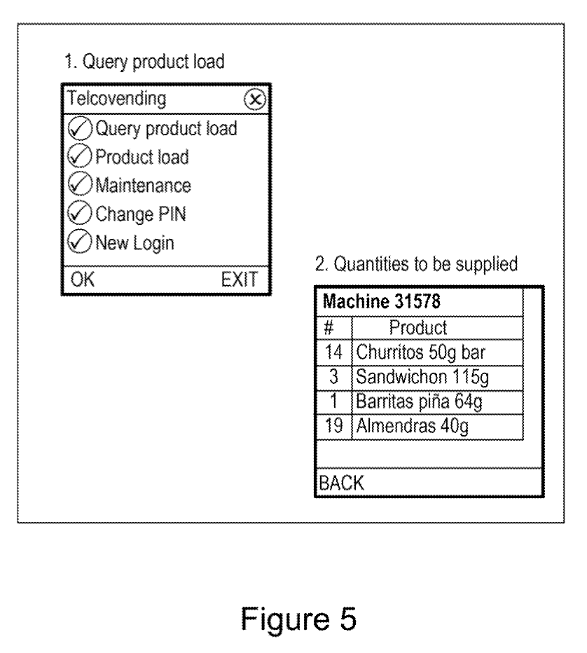

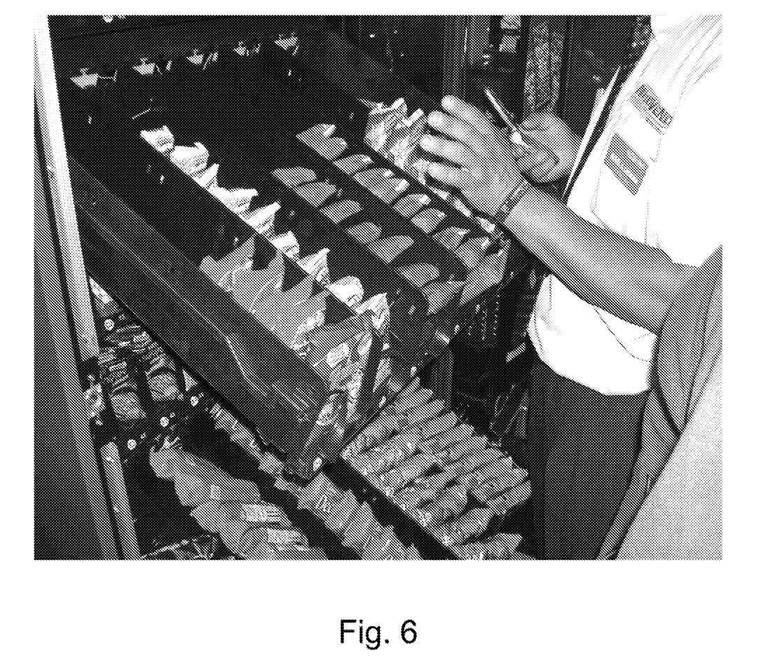

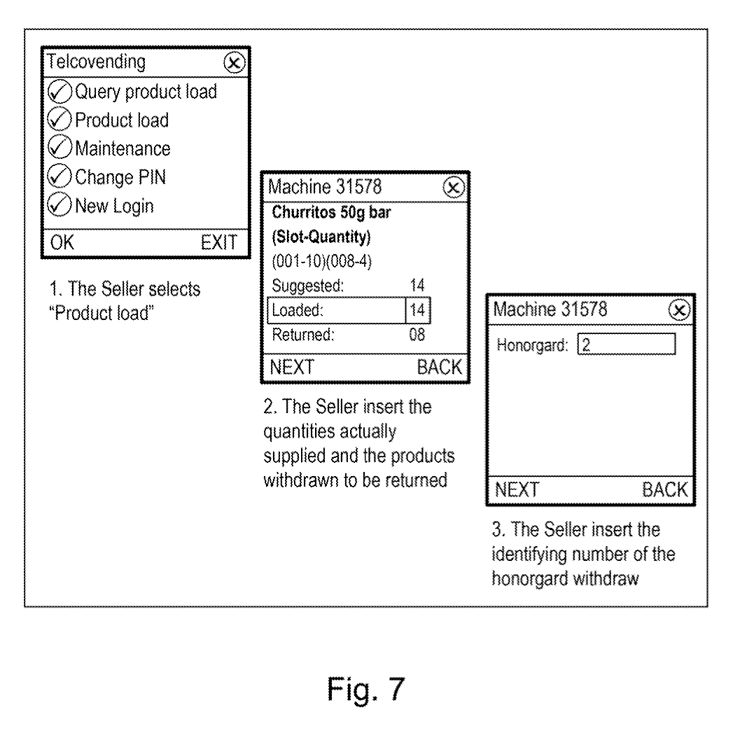

2) Replenishment and collection. By using TELCOMOBILE, the Seller/Replenisher performs the following activities:
From inside the vehicle, he/she checks data referred to the products and quantities to be supplied for certain machines (see FIG. 5).
After taking the products needed from the vehicle, he moves towards the machine, needless to come back to the vehicle.
Once in front of the machine, the system is informed about the beginning of the replenishment process (see FIGS. 6 and 7).
The system suggests the products and quantities to be supplied, based on the sales and replenishment needs since last visit (see FIG. 7).
The system is informed about the quantities actually supplied and expired products to be returned (see FIG. 7).
The identifying number of the honorgard withdrawn is reported to the system (see FIG. 7).

3) Stock Control in the Vehicle and Products to be Returned:
On coming back to the Distribution Center, it is possible to obtain reports indicating the calculated stock in each vehicle. If the Receiver finds any differences, he/she can make the corresponding adjustments.
The system reports the return products and quantities notified by the Seller/Replenisher during the day through TELCOMOBILE. The Receiver validates them and enters into the system the quantities actually received, in case of finding differences in any of the products.

4) Collection settlement. At the end of each day, TELCOVENDING informs the Receiver about the product quantities and collection amount to be expected from each Seller/Replenisher, thus facilitating and speeding up the closing operation, as per the following steps (see FIG. 8):
The system reports the amount of money that should be present in the honorgard of each machine, based on the actual sales performed (data provided by UDANA).
The Settler enters the amount of money actually found within each honorgard.
The system displays a settlement screen indicating values such as amount collected from sales of services, sales of products, valuation of stock inside the vehicle, valuation of returned products, valuation of products supplied in machines, etc.
The system calculates and issues reports to make the settlement between VM operator and Customers.

5) Generation and validation of production requests. The last task of the day is the generation of requests for the production of new products. Based on the activity performed, the historical sales record and other variables, the system generates a suggestion for the production request. The request is validated by an operator and sent to the factory.

### GLOSSARY

Bluetooth: specification for short range, wireless networks (IEEE 802.15).
Distribution Center: place where the products sent by the factory are received, and loaded into a vehicle, and where the Seller/Replenisher daily routine begins, so as to supply the vending machines.
Customer: owner of the place where one or more vending machines operate. Consumer: user who performs a transaction in front of a machine.
Forwarder: member of the staff of the VM operator who is in charge of loading the vehicle at the Distribution Center and of the dispatch of the Seller/Replenisher.
DEX: standard protocol for data transfer between a vending machine and an external device.
Ethernet: name for a computer network technology, based on data frames (IEEE 802.3).
Firmware: programs embedded in hardware devices.
GPRS: acronym for “General Packet Radio Service”. It is a modification in the method of sending data in a GSM network.
GSM: acronym for “Global System for Mobile communications”, the cellular phone network standard most widely used in the world.
Honorgard: bag where the money coming from vending machine sales is kept.
IVR: acronym for “Interactive Voice Response”, a telephone system able to receive a call and interact with a person through voice recordings.
LCD: acronym for “Liquid Crystal Display”, an electrical system which permits displaying data on the basis of liquid crystals.
Machine/vending machine/VM: self-service machine for the sale of products.
MDB: a communication standard protocol between the controller of a vending machine and the peripherals composing it (coin mechanism, etc).
Coin mechanism: a device which recognizes and stores coins, which can be credited in a system to purchase goods or services.
NFC: acronym for “Near Field Communication”, a short range wireless communication technology.
Cellular operator: a company which renders cell phone services for communication by voice, text messages, mobile Internet, etc.
VM operator: a company owning the vending machines, which assigns the machines to different points of sales, replenishes products, collects the money, etc.
Receiver: a member of the staff of the VM operator, who receives the Seller/Replenisher at the Distribution Center.
Replenishment/Supply: loading of products into the machine. Spiral: product container within the machine.
SMS: acronym for “Short Message Service”. It identifies the text messages sent from or to a cell phone.
USSD: acronym for “Unstructured Supplementary Service Data”, a GSM bearer used for forwarding information in data format; it provides a continuous, safe and interactive dialogue between a mobile terminal and a server.
Seller/Replenisher: member of the staff of the VM operator who visits the machines, and performs product supply and maintenance tasks.

### VM: see Machine.

WIFI: a set of standards for wireless networks (IEEE 802.11).
WIMAX: acronym for “Worldwide Interoperability for Microwave Access”, a wireless data transmission standard (IEEE 802.16)

1. A system for the sale of intangible products through a vending machine, comprising:
a controlling device placed within the vending machine,
an application running on a cell phone of a staff member of a vending machine (VM) operator working in the field;
at least one application running on a personal computer of a staff member of the VM operator working within a facility of the VM operator; and
a computer system which manages all of the above-mentioned components.

2. The system of claim 1, in which the computer system comprises: procedures, hardware equipment, including servers and communication equipment, and software component, including services, web services, management services, and databases.

3. The system of claim 2, in which the computer system is able to intercommunicate cell phone operators platforms, including top-up and SMS/USSD, financial institutions, including banks, credit card issuers, collection networks, and transactional switches, and other diverse institutions, including VM operator specific systems and intangible products providers specific systems, as well as hardware components for specific or general purposes.

4. The system of claim 1, in which the computer system enables the purchase of tangible and intangible products from the vending machine, as well as remote management of a plurality of vending machines.

5. The system of claim 4, in which the purchase of tangible and intangible products is initiated by a user by establishing direct communication with the system, through any cell phone communication modality, including IVR, SMS, Mobile Internet, and USSD.

6. The system of claim 4, in which the purchase of tangible and intangible products is initiated by a user by establishing direct communication with the controlling device placed within the vending machine, by using a keyboard or keypad, a wireless connection, including Bluetooth and NFC, or any other user interface with similar features.

7. The system of claim 4, in which the purchase of tangible and intangible products can be made through any of the following payment methods: prepaid cell phone minutes, post-paid bills associated to the cell phone, credit or debit card, lunch tickets, and corporate benefit systems associated to the system.

8. A system for the sale of intangible products through a vending machine, comprising:
a controlling device placed within the vending machine,
an application running on a hand-held, PDA electronic device, or other device with similar features of a staff member of a vending machine (VM) operator working in the field;
at least one application running on a personal computer of a staff member of the VM operator working within a facility of the VM operator; and
a computer system which manages all of the above-mentioned components.

9. The system of claim 8, in which the at least one application running on the personal computer of the staff member of the VM operator working within a facility of the VM operator runs at a local level or through a web application.

10. The system of claim 8, wherein the controlling device placed within the vending machine has a communication system based on one or several of the following wireless communication protocols: GPRS, WIMAX, WIFI and satellite.

11. The system of claim 8, wherein the controlling device placed within the vending machine has a communication system based on one or several of the following wired communication protocols: Ethernet and land telephone lines.

12. The system of claim 8, wherein the controlling device placed within the vending machine, includes an interface to establish communication with a user comprising one or several of the following devices: a keyboard or keypad, a thermal printer, an LCD display, NFC wireless transmitter/receiver and a wireless Bluetooth receiver/transmitter.

13. The system of claim 1, in which the at least one application running on the personal computer of the staff member of the VM operator working within a facility of the VM operator runs at a local level or through a web application.

14. The system of claim 1, wherein the controlling device placed within the vending machine has a communication system based on one or several of the following wireless communication protocols: GPRS, WIMAX, WIFI and satellite.

15. The system of claim 1, wherein the controlling device placed within the vending machine has a communication system based on one or several of the following wired communication protocols: Ethernet and land telephone lines.

16. The system of claim 1, wherein the controlling device placed within the vending machine, includes an interface to establish communication with a user comprising one or several of the following devices: a keyboard or keypad, a thermal printer, an LCD display, NFC wireless transmitter/receiver and a wireless Bluetooth receiver/transmitter.
